(19) United States
(12) Patent Application Publication
(10) Pub. No.: US 2026/0075646 A1
(43) Pub. Date: Mar. 12, 2026

(54) MIXED CHANNEL-OCCUPANCY TIME

(71) Applicant: QUALCOMM INCORPORATED, San Diego, CA (US)

(72) Inventors: Siyi CHEN, Beijing (CN); Jing SUN, San Diego, CA (US); Chih-Hao LIU, San Diego, CA (US); Xiaoxia ZHANG, San Diego, CA (US); Changlong XU, Beijing (CN); Shaozhen GUO, Beijing (CN); Luanxia YANG, Beijing (CN); Hao XU, Beijing (CN)

(21) Appl. No.: 18/872,539

(22) PCT Filed: Aug. 12, 2022
(86) PCT No.: PCT/CN2022/112100

§ 371 Date: Dec. 6, 2024

(51) Int. Cl. H04W 74/0808; H04L 27/26

(52) U.S. Cl. CPC H04W 74/0808; H04L 27/2607

(57) ABSTRACT

Various aspects of the present disclosure generally relate to wireless communication. In some aspects, a wireless communication device (WCD) may receive, from one or more additional WCDs, one or more indications of available resource block sets and associated cyclic prefix extension (CPE) configurations, the available resource block sets associated with a mixed channel-occupancy time (COT). The WCD may modify at least one of the CPE configurations to time-align the available resource block sets for transmission of one or more communications. The WCD may transmit the one or more communications via the available resource block sets. Numerous other aspects are described.

### FIELD OF THE DISCLOSURE

Aspects of the present disclosure generally relate to wireless communication and to techniques and apparatuses for mixed channel-occupancy time.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a wireless communication device (WCD). The method may include receiving, from one or more additional WCDs, one or more indications of available resource block (RB) sets and associated cyclic prefix extension (CPE) configurations, the available RB sets associated with a mixed channel-occupancy time (COT). The method may include modifying at least one of the CPE configurations to time-align the available RB sets for transmission of one or more communications. The method may include transmitting the one or more communications via the available RB sets.

Some aspects described herein relate to a WCD for wireless communication. The wireless communication device may include a memory and one or more processors coupled to the memory. The one or more processors may be configured to receive, from one or more additional WCDs, one or more indications of available RB sets and associated CPE configurations, the available RB sets associated with a mixed COT.

The one or more processors may be configured to modify at least one of the CPE configurations to time-align the available RB sets for transmission of one or more communications. The one or more processors may be configured to transmit the one or more communications via the available RB sets.

Some aspects described herein relate to a non-transitory computer-readable medium that stores a set of instructions for wireless communication by a WCD. The set of instructions, when executed by one or more processors of the WCD, may cause the WCD to receive, from one or more additional WCDs, one or more indications of available RB sets and associated CPE configurations, the available RB sets associated with a mixed COT. The set of instructions, when executed by one or more processors of the WCD, may cause the WCD to modify at least one of the CPE configurations to time-align the available RB sets for transmission of one or more communications. The set of instructions, when executed by one or more processors of the WCD, may cause the WCD to transmit the one or more communications via the available RB sets.

Some aspects described herein relate to an apparatus for wireless communication. The apparatus may include means for receiving, from one or more additional WCDs, one or more indications of available RB sets and associated CPE configurations, the available RB sets associated with a mixed COT. The apparatus may include means for modifying at least one of the CPE configurations to time-align the available RB sets for transmission of one or more communications. The apparatus may include means for transmitting the one or more communications via the available RB sets.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example of communications via resource block (RB) sets in a listen-before-talk (LBT)-based network, in accordance with the present disclosure.

FIG. 7 is a diagram illustrating examples of channel occupancy time (COT)-sharing, in accordance with the present disclosure.

FIG. 8 is a diagram of an example associated with mixed COT, in accordance with the present disclosure.

FIG. 9 is a diagram illustrating an example of communications via RB sets in an LBT-based network, in accordance with the present disclosure.

FIG. 10 is a diagram illustrating an example of communications via RB sets in an LBT-based network, in accordance with the present disclosure.

FIG. 11 is a diagram illustrating an example of communications via RB sets in an LBT-based network, in accordance with the present disclosure.

FIG. 12 is a diagram illustrating an example process performed, for example, by a wireless communication device (WCD), in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

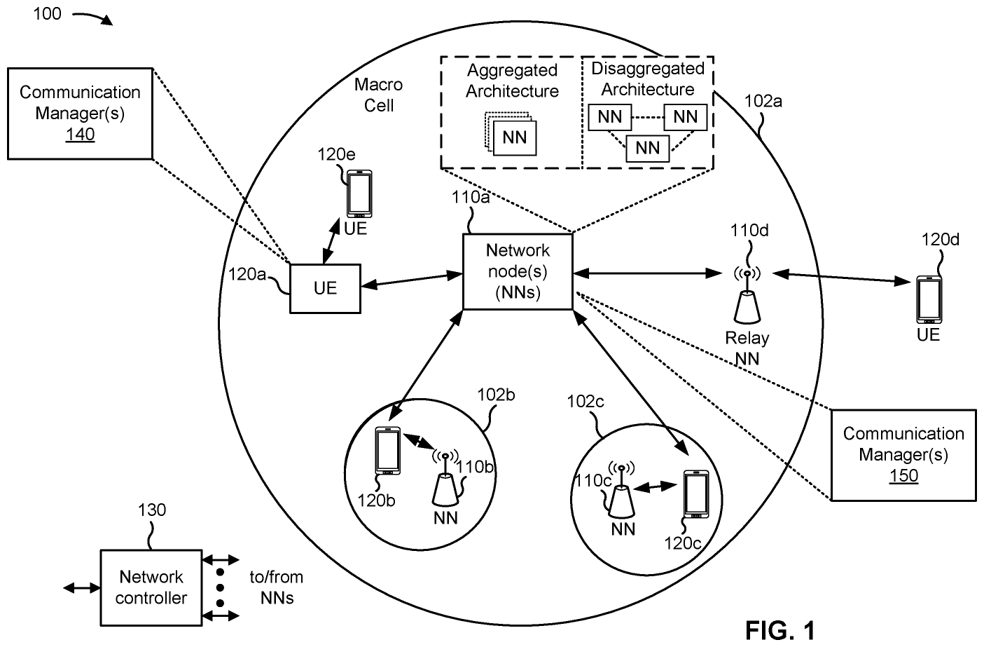

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a wireless communication device (WCD) (e.g., a network node 110 or a UE 120) may include a communication manager 140 or 150. As described in more detail elsewhere herein, the communication manager 140 or 150 may receive, from one or more additional WCDs, one or more indications of available resource block (RB) sets and associated cyclic prefix extension (CPE) configurations, the available RB sets associated with a mixed channel occupancy time (COT); modify at least one of the CPE configurations to time-align the available RB sets for transmission of one or more communications; and transmit the one or more communications via the available RB sets. Additionally, or alternatively, the communication manager 140 or 150 may perform one or more other operations described herein.

As indicated above, FIG. 1 is provided as an example. Other examples may differ from what is described with regard to FIG. 1.

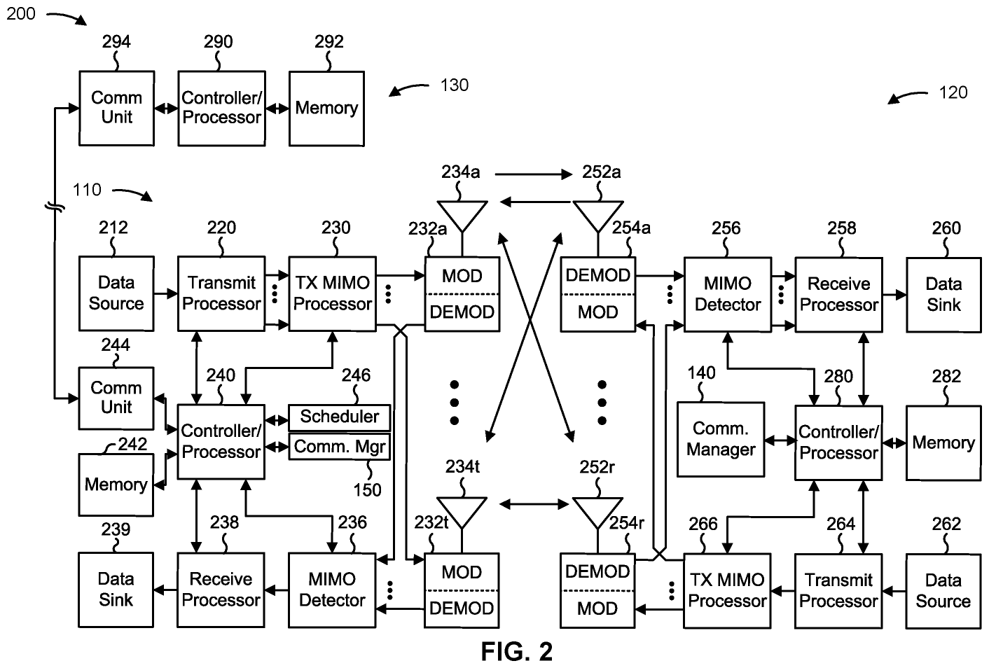

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

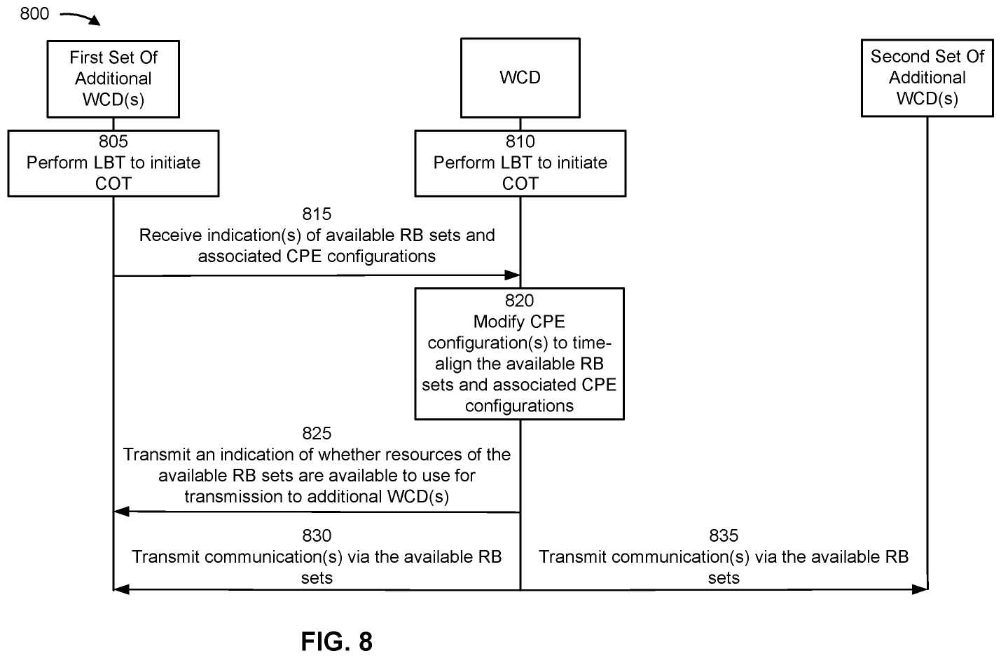

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-13).

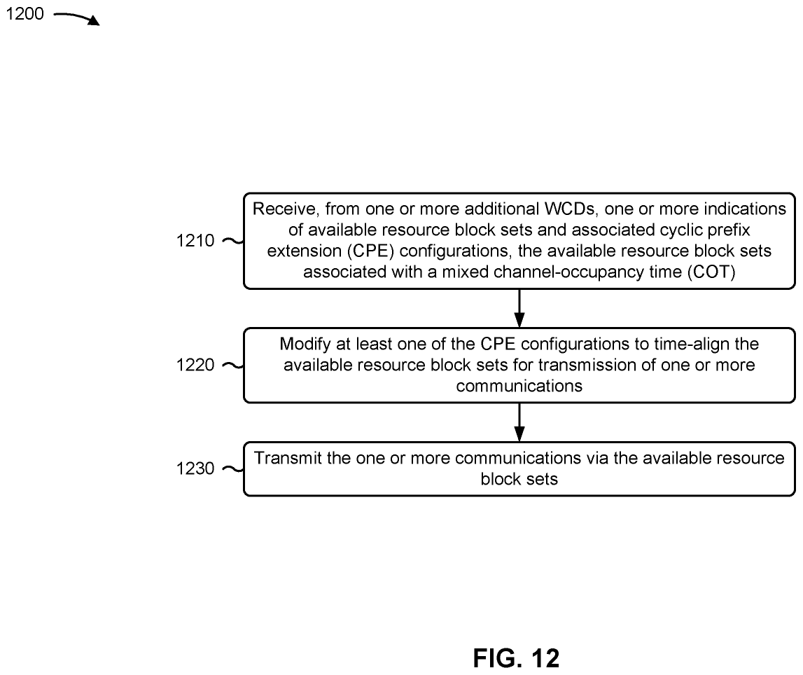

The controller/processor 240 of the network node 110, the controller/processor 280 of the UE 120, and/or any other component(s) of FIG. 2 may perform one or more techniques associated with mixed COT, as described in more detail elsewhere herein. For example, the controller/processor 240 of the network node 110, the controller/processor 280 of the UE 120, and/or any other component(s) of FIG. 2 may perform or direct operations of, for example, process 1200 of FIG. 12 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1200 of FIG. 12 and/or other processes as described herein. In some examples, executing instructions may include running the instructions, converting the instructions, compiling the instructions, and/or interpreting the instructions, among other examples.

In some aspects, a WCD (e.g., the UE 120 or the network node 110) includes means for receiving, from one or more additional WCDs, one or more indications of available RB sets and associated CPE configurations, the available RB sets associated with a mixed COT; means for modifying at least one of the CPE configurations to time-align the available RB sets for transmission of one or more communications; and/or means for transmitting the one or more communications via the available RB sets. In some aspects, the means for the WCD to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the WCD to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

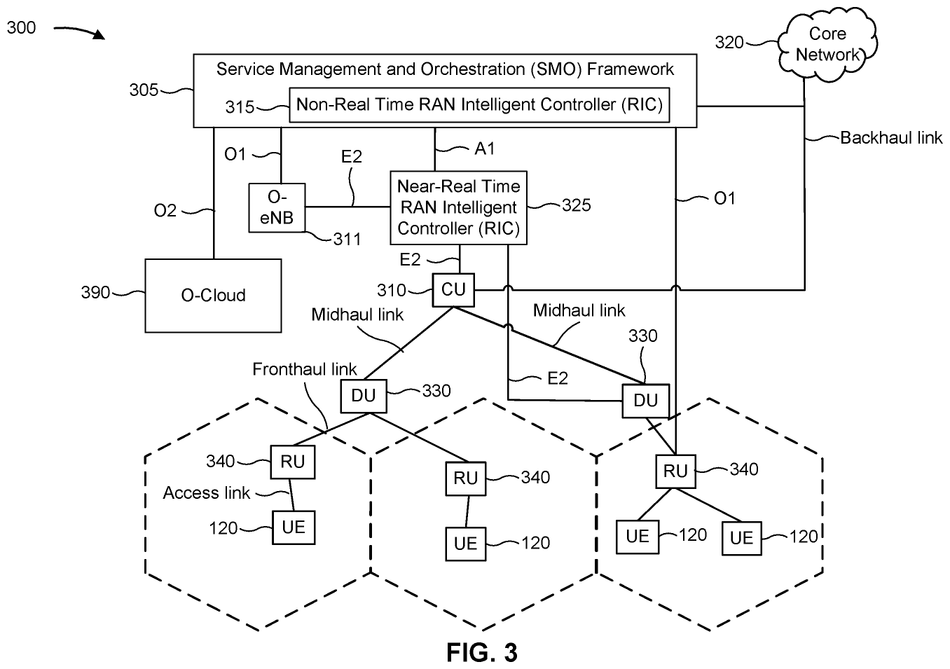

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

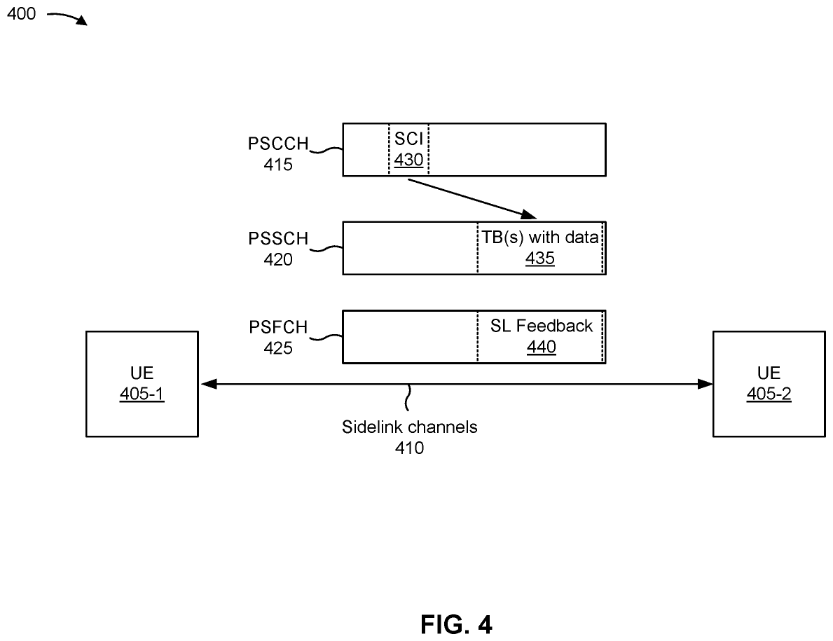

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QOS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 420, such as a HARQ process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific RBs across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a network node 110 (e.g., a base station, a CU, or a DU). For example, the UE 405 may receive a grant (e.g., in downlink control information (DCI) or in an RRC message, such as for configured grants) from the network node 110 (e.g., directly or via one or more network nodes) for sidelink channel access and/or scheduling. In some aspects, a UE 405 may operate using a transmission mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s)

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of RBs that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more RBs to be used for the upcoming sidelink transmission on the PSSCH 420 (e.g., for TBs 435), one or more subframes to be used for the upcoming sidelink transmission, and/or an MCS to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As indicated above, FIG. 4 is provided as an example. Other examples may differ from what is described with respect to FIG. 4.

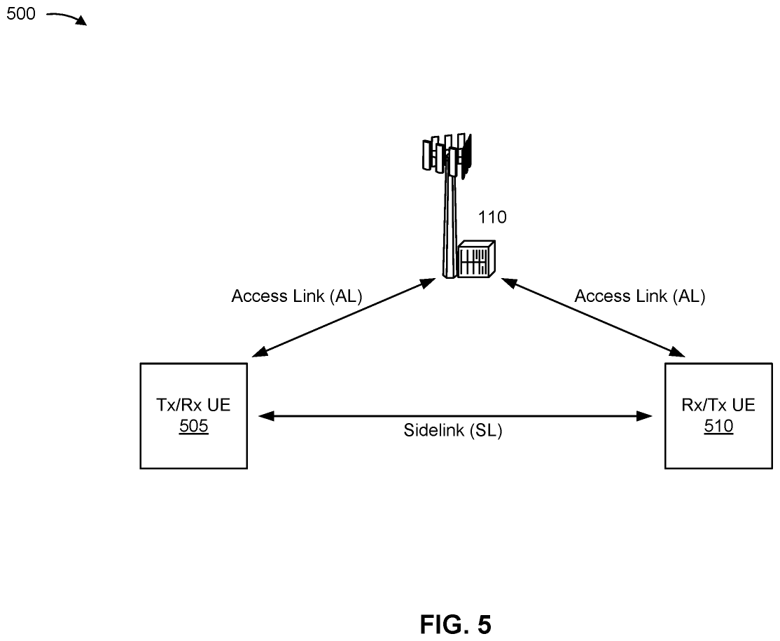

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a network node 110 may communicate with the Tx/Rx UE 505 (e.g., directly or via one or more network nodes), such as via a first access link. Additionally, or alternatively, in some sidelink modes, the network node 110 may communicate with the Rx/Tx UE 510 (e.g., directly or via one or more network nodes), such as via a first access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a network 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 5 is provided as an example. Other examples may differ from what is described with respect to FIG. 5.

In a shared or unlicensed frequency band, a transmitting device may contend against other devices for channel access before transmitting on a shared or unlicensed channel to reduce and/or prevent collisions on the shared or unlicensed channel. To contend for channel access, the transmitting device may perform a channel access procedure, such as a listen-before-talk (or listen-before-transmit) (LBT) operation or another type of channel access procedure, for shared or unlicensed frequency band channel access. The channel access procedure may be performed to determine whether the physical channel (e.g., the radio resources of the channel) is available to use or is busy (e.g., in use by another wireless communication device such as a UE, an IoT device, or a WLAN device, among other examples). The channel access procedure may include sensing or measuring the physical channel (e.g., performing an RSRP measurement, detecting an energy level, or performing another type of measurement) during a channel access gap (which may also be referred to as a contention window (CW)) and determining whether the shared or unlicensed channel is available or busy based at least in part on the signals sensed or measured on the physical channel (e.g., based at least in part on whether the measurement satisfies a threshold). If the transmitting device determines that the channel access procedure was successful (e.g., the shared or unlicensed channel is available), the transmitting device may perform one or more transmissions on the shared or unlicensed channel during a transmission opportunity (TXOP), which may extend for a COT.

In some networks, a first WCD may perform the channel access procedure and may indicate, to a second WCD, whether a channel is available or busy. For example, a first UE may sense the channel to determine availability of one or more sets of RB sets and may transmit an indication, to a second UE, that the one or more sets of RB sets are available for use by the second UE. The first WCD may transmit using the channel before transmitting the indication to the second WCD.

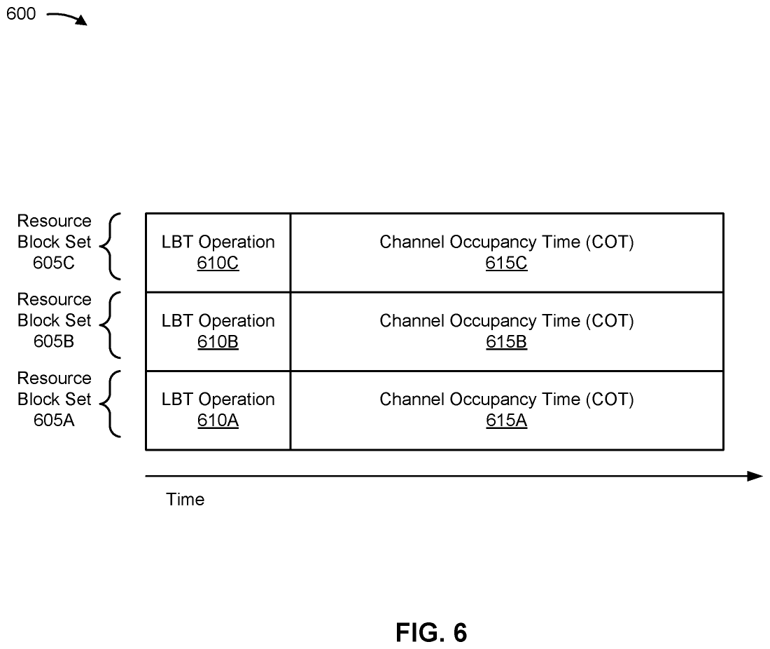

FIG. 6 is a diagram illustrating an example 600 of communications via RB sets in an LBT-based network, in accordance with the present disclosure.

As shown in FIG. 6, a set of RB sets (e.g., a portion of a shared or unlicensed channel in a frequency domain) may include an RB set 605A, an RB set 605B, and an RB set 605C. To gain access to the RB sets, a WCD may perform an LBT operation associated with the RB set. For example, the WCD may perform LBT operation 610A to gain access to the RB set 605A, LBT operation 610B to gain access to the RB set 605B, and LBT operation 610C to gain access to the RB set 605C.

An LBT operation, as described herein, may refer to any channel access procedure. For example, channel access procedures may include a Type A channel access procedure, where a WCD (e.g., a sensing WCD and/or a COT-initiating WCD) performs parallel independent backoff procedures on each channel and each channel needs to complete the Type 1 LBT individually before the UE can perform simultaneous transmissions on each channel. Additionally, or alternatively, channel access procedures may include a TYPE B channel access procedure where the WCD performs a single random backoff procedure (Type 1 LBT) on one of the channels and a clear channel assessment (CCA) check is required on other channels just before the transmission on each of the channels.

For a load based equipment (LBE) channel, a WCD may use a Type 1 LBT for COT channel access. The Type 1 LBT may include a Cat 4 LBT, which is an LBT with a random backoff. The backoff (e.g., an amount of time during which the channel is available before the WCD can begin a COT) may have a duration that includes a defer period and one or more additional sensing slots.

Type 2 LBT may include a configuration, such as Type 2A LBT, Type 2B LBT, or Type 2C LBT. In Type 2A LBT, a network node may transmit a downlink transmission after (e.g., immediately after) sensing the channel to be idle for at least a sensing interval that satisfies a first threshold (e.g., is at least as long as the first threshold). For example, the threshold may be 25 microseconds (us) with a channel access gap that is greater than or equal to 25 us. In Type 2B LBT, a network node may transmit a downlink transmission immediately after sensing the channel to be idle within a duration window. For example, the duration window may be between 16 us and 25 us with a channel gap that is between 16 us and 25 us. In Type 2C LBT, a network node may not sense the channel before transmitting the downlink transmission. In this case, the gap may satisfy a second threshold (e.g., may be less than or equal to the second threshold).

After performing the LBT operation associated with the RB set, the WCD may have associated COTs on the RB sets. For example, the WCD may have COT 615A on the RB set 605A, COT 615B on the RB set 605B, and COT 615C on the RB set 605C. In some networks, the WCD may transmit communications to a single additional WCD or to multiple WCDs. In some networks, the WCD may transmit a same communication or different communications during the COTs.

As indicated above, FIG. 6 is provided as an example. Other examples may differ from what is described with respect to FIG. 6.

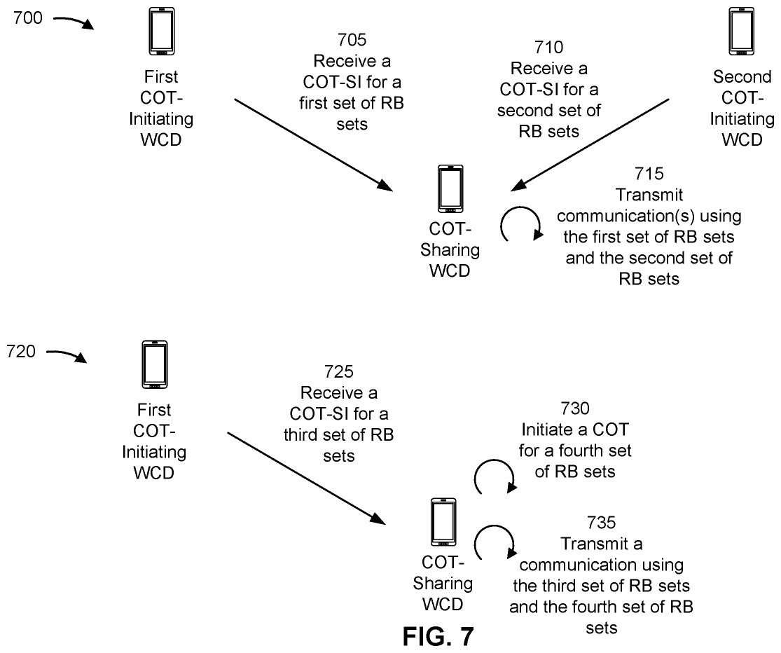

FIG. 7 is a diagram illustrating examples 700 and 720 of COT-sharing, in accordance with the present disclosure. Although shown in FIG. 7 as UEs, the WCDs of FIG. 7 may be any time of WCD, such as a network node, a UE, and/or a repeater, among other examples.

As shown in example 700, and by reference number 705, a COT-sharing WCD (e.g., a WCD that receives resources of the channel from another WCD) may receive a COT structure indication (COT-SI) for a first set of RBs from a first COT-initiating WCD. For example, the first COT-initiating WCD may perform a channel access procedure on the first set of RB sets and may indicate that the first set of RB sets are available to the COT-sharing WCD. As shown by reference number 710, the COT-sharing WCD may receive a COT-SI for a second set of RB sets from a second COT-initiating WCD. As shown by reference number 715, the COT-sharing WCD may transmit one or more communication(s) using the first set of RB sets and the second set of RB sets. Example 700 may be referred to as mixed COT sharing based at least in part on the COT-sharing WCD receiving the COT-SI from multiple COT-initiating WCDs.

As shown in example 720, and by reference number 725, a COT-sharing WCD may receive a COT-SI for a third set of RB sets from the first COT-initiating WCD. For example, the first COT-initiating WCD may perform a channel access procedure on the third set of RB sets and may indicate that the third set of RB sets are available to the COT-sharing WCD. As shown by reference number 730, the COT-sharing WCD may initiate a COT (e.g., perform a channel access procedure) for a fourth set of RB sets. As shown by reference number 735, the COT-sharing WCD may transmit one or more communication(s) using the third set of RB sets and the fourth set of RB sets. Example 720 may be referred to as partial COT sharing (a type of mixed COT sharing) based at least in part on the COT-sharing WCD receiving the COT-SI for a first subset of RB sets and performing COT channel access procedure for a second subset of RB sets.

In some networks, a network node (e.g., a COT-initiating WCD) may contend for a channel in frequency units (e.g., 20 megahertz (MHz) units) and may provide the COT-sharing WCD (e.g., a UE) with information on time and frequency domain spans of a current channel occupancy. For example, in a frequency domain COT, the network node may introduce a bitmap to indicate the available LBT bandwidths. The indication of available LBT bandwidths may be valid until an end of a determined channel occupancy. In a time domain COT, the network node may introduce a COT duration bit-field per serving cell and/or may indicate a remaining length from a beginning of a slot when the information is received.

In some networks (e.g., NR networks), wider carriers may be used (e.g., up to 100 MHz with 30 kilohertz (KHz) subcarrier spacing), and a sidelink-user configuration may specify a wideband operation where a carrier consists of multiple LBT bandwidths, which is 20 MHz in a 5 GHz and/or 6 GHz unlicensed band.

As indicated above, FIG. 7 is provided as an example. Other examples may differ from what is described with respect to FIG. 7.

In some networks, wideband transmissions may be used for increased throughputs. For example, a WCD (e.g., a COT-sharing WCD) may efficiently communicate if allowed to use multiple LBT bandwidths (e.g., multiple RB sets).

However, if the WCD receives COT-SIs (and/or an indication of available RB sets) from different additional WCDs (e.g., COT-initiating WCDs), CPEs of the RB sets may not align. For example, if the RB sets are associated with a channel access procedure with different LBT types and different gap durations, CPEs of simultaneous RB sets will begin at different times, which may consume power and/or communication resources of the WCD and/or may cause the WCD to lose access to the RB sets.

In some aspects described herein, a WCD (e.g., a UE) may be configured with a CPE configuration control (e.g., indicated in a communication protocol and/or via configuration information from an associated network) for mixed COT source transmissions and/or partial COT sharing transmissions. For example, the WCD may receive, from one or more additional WCDs (e.g., COT-initiating WCDs), one or more indications of available RB sets and associated CPE configurations. The available RB sets may be associated with a mixed COT. The WCD may modify (e.g., based at least in part on the CPE configuration control information) at least one of the CPE configurations to time-align the available RB sets for transmission of one or more communications. After time-aligning the available RB sets, the WCD may transmit the one or more communications via the available RB sets.

Based at least in part on time-aligning the available RB sets, the WCD may improve throughput based at least in part on maintaining access to the available RB sets and may improve power efficiency based at least in part on using simultaneous transmission of the CPEs and the communications via multiple RB sets of the available RB sets.

In some aspects, the WCD may maintain (e.g., refrain from modifying) indicated LBT types (e.g., CPE lengths) if all LBT bandwidths start at a same time and/or CPE lengths are a same length. In some aspects, if the LBT bandwidths (e.g., RB sets) are misaligned (e.g., at a starting point), the WCD may pick a last starting time and/or upgrade an LBT Type to Type 2A. In some aspects, if the LBT bandwidths are misaligned, the WCD may pick an earliest starting time and maintain the LBT type for the LBT bandwidths. For Type 2A, the WCD may pick an earliest starting time only when a gap (e.g., channel access gap) between a last transmitted slot in an associated COT and an earliest starting point is still greater than or equal to a threshold amount of time (e.g., 25 us). In some aspects, for self-initiated RB sets, the WCD may use a same starting point as other LBT bandwidths (e.g., using a starting point indicated in another LBT bandwidth) to align a starting point among different RB sets. The Typel LBT used for self-initiation may be finished before the starting point.

In some aspects, the WCD may modify the at least one of the CPE configurations based at least in part on types of LBT operations used to obtain COT for the RB sets. For example, if a first RB set uses Type 2A and a second RB set uses Type 2A, a starting time for the CPE may be maintained as a starting time indicated for both RB sets if the starting times match (e.g., align in time within a threshold amount of time), or the WCD may select a latest of starting times indicated for either the first RB set or the second RB set.

If a first RB set uses Type 2B and a second RB set uses Type 2B, a starting time for the CPE may be maintained as a starting time indicated for both RB sets if the starting times match, or the WCD may select a latest of starting times indicated for either the first RB set or the second RB set and/or may upgrade the RB set associated with the earlier starting point to Type 2A.

If a first RB set uses Type 2C and a second RB set uses Type 2C, a starting time for the CPE may be maintained as a starting time indicated for both RB sets if the starting times match. If the starting times do not match, the WCD may select an earliest starting time indicated for either the first RB set or the second RB set and/or may maintain using Type 2C for both RBs. Alternatively, if the starting times do not match, the WCD may select a latest starting time indicated for either the first RB set or the second RB set and/or may upgrade the RB set associated with the earlier starting point to Type 2A.

If a first RB set uses Type 2A and a second RB set uses Type 2B, a starting time for the CPE may be maintained as a starting time indicated for both RB sets if the starting times match. If the starting times do not match, the WCD may select an earliest starting time indicated for either the first RB set or the second RB set if a gap after selecting the earliest starting point satisfies a threshold (e.g., the gap is at least 25 us for the first RB set). Alternatively, if the starting times do not match, the WCD may select a latest starting time indicated for either the first RB set or the second RB set and/or may upgrade the second RB set to Type 2A.

If a first RB set uses Type 2A and a second RB set uses Type 2C, a starting time for the CPE may be maintained as a starting time indicated for both RB sets if the starting times match. If the starting times do not match, the WCD may select an earliest starting time indicated for either the first RB set or the second RB set if a gap after selecting the earliest starting point satisfies a threshold (e.g., the gap is at least 25 us for the first RB set). Alternatively, if the starting times do not match, the WCD may select a latest starting time indicated for either the first RB set or the second RB set and/or may upgrade the second RB set to Type 2A.

If a first RB set uses Type 2B and a second RB set uses Type 2C, a starting time for the CPE may be maintained as a starting time indicated for both RB sets if the starting times match. If the starting times do not match, the WCD may select a latest starting time indicated for either the first RB set or the second RB set and/or may upgrade the RB set with an earliest indicated starting point to Type 2A.

If a first RB set uses Type 2A, a second RB set uses Type 2B, and a third RB set uses Type 2C, a starting time for the CPE may be maintained as a starting time indicated for all three RB sets if the starting times match. If the starting times do not match, the WCD may select an earliest starting time indicated for either the first RB set, the second RB set, or the third RB set, if a gap after selecting the earliest starting point satisfies a threshold (e.g., the gap is at least 25 us for the first RB set) for the first RB set. Alternatively, if the starting times do not match, the WCD may select a latest starting time indicated for either the first RB set, the second RB set, or the third RB set and/or may upgrade the second RB set and the third RB set to Type 2A.

If a first RB set uses Type 1 and a second RB set uses Type 2 (e.g., in a partial COT sharing transmission), a starting time for the CPE may be maintained as a starting time indicated for both RB sets if the starting times match. If the starting times do not match, the WCD may modify the starting time of the first RB set to be the starting time of the second RB set.

In some aspects where the WCD upgrades an LBT type for an RB set, a COT-initiating WCD may use the RB set if the COT-initiating WCD is unaware of the upgrade. For example, the COT-initiating WCD may determine that the WCD is not using the RB set based at least in part on failing to begin transmission of an associated CPE.

To make the COT-initiating WCD aware of the upgrade or a potential upgrade, the COT-initiating WCD may indicate whether the LBT type for the RB set can be upgraded. For example, the COT-initiating WCD may indicate that the LBT type cannot be upgraded if the COT-initiating WCD intends to use the RB set for transmission of data to an additional WCD using the COT associated with the RB set. In this way, the WCD (e.g., a COT-sharing WCD) may not be able to use the RB set as a mixed COT source if starting points are misaligned. Alternatively, the COT-initiating WCD may indicate that the LBT type may be upgraded (e.g., based at least in part on the COT-initiating WCD not intending to use the RB set for transmission of data).

Additionally, or alternatively, to make the COT-initiating WCD aware of the upgrade, the WCD may transmit an indication of whether the COT-initiating WCD may use the RB set for transmission of data to an additional WCD using the COT associated with the RB set. If the LBT type has been upgraded to a Type 2A and a gap between a last transmitted slot in the COT and the starting point satisfies the threshold (e.g., is larger than 25 us), this COT may not be used for transmissions to other WCDs. In SCI, this indication may indicate whether this COT can be further used to transmit to other UEs or not (e.g., using 1 bit), and may also indicate which LBT bandwidths cannot be used to transmit to other UEs by using a bitmap (e.g., to indicate the unavailable LBT bandwidth starting from an associated SCI-1 reception LBT bandwidth). In this way, the COT-initiating UE is aware of whether the COT is available to the COT-initiating UE for transmissions. If the LBT type has been upgraded to Type 2A LBT and the gap satisfies the threshold, the WCD should use Type 1 LBT to initiate a new COT to transmit data to another WCD.

In some aspects, traffic may be restricted based at least in part on WCDs that performed channel access operations for the associated sets of RB sets.

In some aspects, the WCD may only transmit communications using RB sets to the WCDs that performed the channel access operation on the RB sets. For example, if a first WCD performed a channel access operation of a first RB set and a second RB set, and a second WCD performed a channel access operation of a third RB set, the WCD may be configured to use the first and second RB sets for transmission of communications only to the first WCD and to use the third RB set for transmission of communications only to the second WCD.

In some aspects, if the WCD may transmit a communication to an additional WCD using a set of RB sets only if the WCD performed a channel access operation (e.g., initiated COT) on at least one RB set included in set of RB sets, or only if the additional WCD performed a channel access operation (e.g., initiated COT) on at least one RB set included in the set of RB sets. In some aspects, if the WCD may transmit a communication to the additional WCD using the set of RB sets only if the WCD performed a channel access operation (e.g., initiated COT) on a threshold number or threshold proportion of RB sets included in set of RB sets, or only if the additional WCD performed a channel access operation (e.g., initiated COT) on a threshold number or threshold proportion of RB sets included in set of RB sets. In some aspects, the threshold number or threshold proportion of RB sets may be based at least in part on a ratio indicated by the network and/or in a communication protocol. In some aspects, the threshold number or threshold proportion of RB sets may be based at least in part on an indicated pairing of a number of RB sets in the set of RB sets and a number of RB sets having the channel access operation performed by the WCD or the additional WCD.

For example, in a partial COT sharing scenario, RB set 1 is shared from WCD 1, and RB set 2 and RB set 3 are initiated by the WCD. If the threshold is 0.6., the WCD can use RB sets 1, 2, and/or 3 toward any UE (e.g., because 2/3>0.6).

In an example of mixed COT sharing, RB set 1 is shared from WCD 1, RB set 2 and RB set 3 are shared from WCD 2, and the threshold is 0.6. If the WCD wants to transmit to WCD 2 by using RB sets 1, 2, and/or 3, the WCD can use the shared COT (e.g., because 2/3>0.6). If the WCD wants to transmit to WCD 1 by using RB sets 1, 2, and/or 3, the WCD cannot use this shared COT (e.g., because 1/3<0.6).

In some networks, a Type B multi-channel access procedure is defined where a primary channel is selected among channels that the WCD (e.g., a network node or a UE) intends to use to transmit a communication. For a mixed COT source, if the primary channel falls into a channel in a shared COT, the WCD may upgrade a Cat4 LBT to a Cat2 LBT. This may unfairly give the WCD an advantage in occupying the channel as compared to other WCDs attempting to gain access. In some aspects, the WCD may be configured to randomly select a channel as a primary channel among all the LBT bandwidth that has not been initiated yet (e.g., based at least in part on a COT-SI at that time).

FIG. 8 is a diagram of an example 800 associated with mixed COT, in accordance with the present disclosure. As shown in FIG. 8, a WCD (e.g., a UE 120, a network node 110, a CU, a DU, and/or an RU) may communicate with a first set of one or more additional WCDs (e.g., a UE 120, a network node 110, a CU, a DU, and/or an RU) and/or a second set of one or more additional WCDs (e.g., a UE 120, a network node 110, a CU, a DU, and/or an RU). In some aspects, the WCD and the additional WCDs may be part of a wireless network (e.g., wireless network 100). The wireless network may use a shared band or an unlicensed band for communications. The wireless network may use one or more channel access operations, such as one or more LBT procedures.

As shown by reference number 805, one or more WCDs of the first set of one or more additional WCDs may perform an LBT operation to initiate a COT on one or more sets of RB sets. An RB set may include a frequency range that includes multiple RBs. In some aspects, an additional WCD may perform an LBT operation on one or more RB sets, which one or more RB sets may be referred to as a set of RB sets. Additionally, or alternatively, as shown by reference number 810, the WCD may perform an LBT operation to initiate a COT on one or more sets of RB sets.

In some aspects, the one or more WCDs of the first set of one or more additional WCDs and/or the WCD may be configured to perform the LBT operation on a randomly selected primary channel within a subset of the available RB sets that are not yet initiated before performance of the LBT operation.

As shown by reference number 815, the WCD may receive, and the first set of one or more additional WCDs may transmit, one or more indications of available RB sets and associated CPE configurations. For example, a first WCD of the set of one or more additional WCDs may transmit an indication of a first available RB set and a second WCD of the set of one or more additional WCDs may transmit an indication of a second available RB set. The first WCD and the second WCD may use different LBT types to acquire channels associated with the first available RB set and the second available RB set. The available RB sets may be associated with a mixed COT (e.g., a mixed COT and/or a partial COT sharing configuration).

In some aspects, the indication of the associated CPE configurations may indicate whether an LBT type, associated with the available RB sets, supports a modification to a different LBT type. For example, whether the WCD may upgrade an LBT type to time-align the CPE start times. In some aspects, the indication may indicate whether a WCD of the one or more additional WCDs may attempt to reclaim the available RBs based at least in part on an amount of time that elapses between transmission of the one or more indications of the available RB sets and transmission by the WCD of a CPE using the available RB sets.

As shown by reference number 820, the WCD may modify one or more CPE configurations to time-align the available RB sets and associated CPE configurations. In some aspects, the WCD may time-align the available RB sets and associated CPE configurations for transmission of one or more communications.

In some aspects, the WCD may modify the one or more CPE configurations by modifying an earliest CPE start time to match a latest CPE start time or modifying the latest CPE start time to match the earliest CPE start time (e.g., as described herein). In some aspects, the WCD may modify a type of LBT applied to the one or more of the CPE configurations (e.g., as described herein as upgrading an LBT type). In some aspects, the WCD may modify a CPE start time associated with a self-initiated COT operation to match a CPE start time of a shared COT operation (e.g., in a partial COT sharing configuration).

In some aspects, the WCD may modify the at least one of the CPE configurations is based at least in part on one or more LBT types associated with the CPE configurations and/or a gap between a latest CPE start time and an end of a latest transmitted slot in a COT operation preceding CPE start time (e.g., as described herein).

As shown by reference number 825, the WCD may transmit an indication of whether resources of the available RB sets are available to use for transmissions to one or more additional WCDs. For example, the WCD may transmit an indication of whether a first available RB set, indicated as available by a first WCD of the one or more additional WCDs, is available for the first WCD to use for transmission of one or more additional WCDs (e.g., without or outside of the first set of one or more WCDs or the second set of one or more WCDs).

In some aspects, the WCD may transmit an indication of LBT bandwidths (e.g., RB sets), of the available RB sets, that are available for the first WCD (e.g., a COT-initiating WCD) to use for transmission to additional WCDs. In some aspects, the WCD may transmit an indication of LBT bandwidths, of the available RB sets, that are not available for the COT-initiating WCD to use for transmission to additional WCDs using the available RB sets. In some aspects, the WCD may indicate LBT bandwidths that are available or not available based at least in part on a bitmap associated with the different LBT bandwidths.

As shown by reference number 830, the WCD may transmit one or more communications, to an additional WCD of the first set of one or more additional WCDs, via the available RB sets. In some aspects, the WCD may transmit a communication, of the one or more communications, to an additional WCD using a subset of the available RB sets. In some aspects, the WCD may use the subset of the available RBs for transmitting the communication to the additional WCD based at least in part on the additional WCD and/or the WCD performing an LBT operation on the subset before transmission of the communication.

In some aspects, the WCD may transmit the communication to the additional WCD using a set of the available RB sets (e.g., all or a subset of the available RB sets) based at least in part on the additional WCD and/or the WCD performing an LBT operation on at least one of the available RB sets or on a portion of the set of available RB sets that satisfies a threshold (e.g., a portion on which the WCD performed the LBT operation, a portion on which the additional WCD performed the WCD performed the LBT operation, or a total portion on which either the WCD or the additional WCD performed the LBT operation).

As shown by reference number 835, the WCD may transmit one or more communications, to an additional WCD of the second set of one or more additional WCDs, via the available RB sets. In some aspects, the WCD may use the subset of the available RBs for transmitting the communication to the additional WCD based at least in part on the WCD performing an LBT operation on the subset before transmission of the communication.

In some aspects, the WCD may transmit the communication to the additional WCD using a set of the available RB sets (e.g., all or a subset of the available RB sets) based at least in part on the WCD performing an LBT operation on at least one of the available RB sets or on a portion of the set of available RB sets that satisfies a threshold.

Based at least in part on time-aligning the available RB sets, the WCD may improve throughput based at least in part on maintaining access to the available RB sets and may improve power efficiency based at least in part on using simultaneous transmission of the CPEs and the communications via multiple RB sets of the available RB sets.

As indicated above, FIG. 8 is provided as an example. Other examples may differ from what is described with respect to FIG. 8.

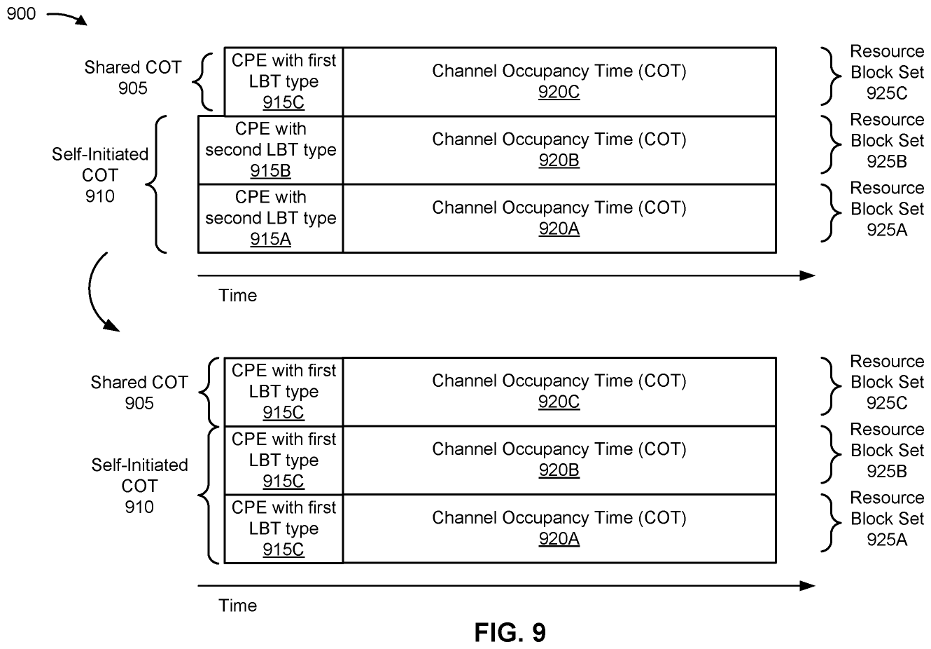

FIG. 9 is a diagram illustrating an example 900 of communications via RB sets in an LBT-based network, in accordance with the present disclosure.

As shown in FIG. 9, a set of RB sets (e.g., a portion of a shared or unlicensed channel in a frequency domain) may include a shared COT 905 and a self-initiated COT 910. The shared COT 905 may be associated with a CPE with a first LBT type 915C (e.g., having a first duration). The self-initiated COT 910 may be associated with a CPE with a second LBT type 915B and a CPE with the second LBT type 915A. The CPE with the first LBT type 915C may be associated with a COT 920C, the CPE with the second LBT type 915B may be associated with a COT 920B, and the CPE with the second LBT type 915A may be associated with a COT 920A. The shared COT 905 may be associated with an RB set 925C and the self-initiated COT 910 may be associated with an RB set 925B and an RB set 925A.

As shown in FIG. 9, an initial configuration of the CPEs 915 result in misaligned starting times. Based at least in part on a communication protocol and/or a configuration, a WCD may modify the CPE configurations associated with the CPE with the second LBT type 915B and 915A to align with the CPE configuration associated with the CPE with the first LBT type 915C. This may be based at least in part on modifying CPE configurations associated with a self-initiated COT 910 to match a CPE configuration associated with a shared COT 905.

As indicated above, FIG. 9 is provided as an example. Other examples may differ from what is described with respect to FIG. 9.

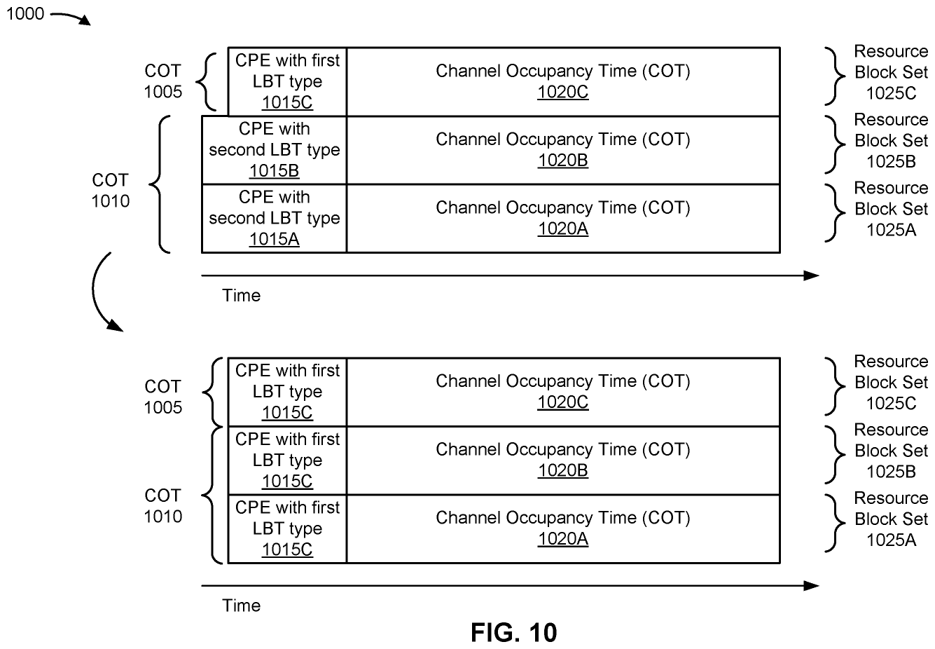

FIG. 10 is a diagram illustrating an example 1000 of communications via RB sets in an LBT-based network, in accordance with the present disclosure.

As shown in FIG. 10, a set of RB sets (e.g., a portion of a shared or unlicensed channel in a frequency domain) may include a COT 1005 and a COT 1010. The COT 1005 may be associated with a CPE with a first LBT type 1015C (e.g., having a first duration). The COT 1010 may be associated with a CPE with a second LBT type 1015B and a CPE with the second LBT type 1015A. The CPE with the first LBT type 1015C may be associated with a COT 1020C, the CPE with the second LBT type 1015B may be associated with a COT 1020B, and the CPE with the first LBT type 1015A may be associated with a COT 1020A. The COT 1005 may be associated with an RB set 1025C and the COT 1010 may be associated with an RB set 1025B and an RB set 1025A.

As shown in FIG. 10, an initial configuration of the CPEs 1015 result in misaligned starting times. Based at least in part on a communication protocol and/or a configuration, a WCD may modify the CPE configurations associated with the CPE with the second LBT type 1015B and 1015A to align with the CPE configuration associated with the CPE with the first LBT type 1015C. This may be based at least in part on modifying CPE configurations associated with an earliest start time to match a CPE configuration associated with a latest start time. In some aspects, the CPE configurations associated with an earliest start time may be upgraded to a Type 2A LBT.

As indicated above, FIG. 10 is provided as an example. Other examples may differ from what is described with respect to FIG. 10.

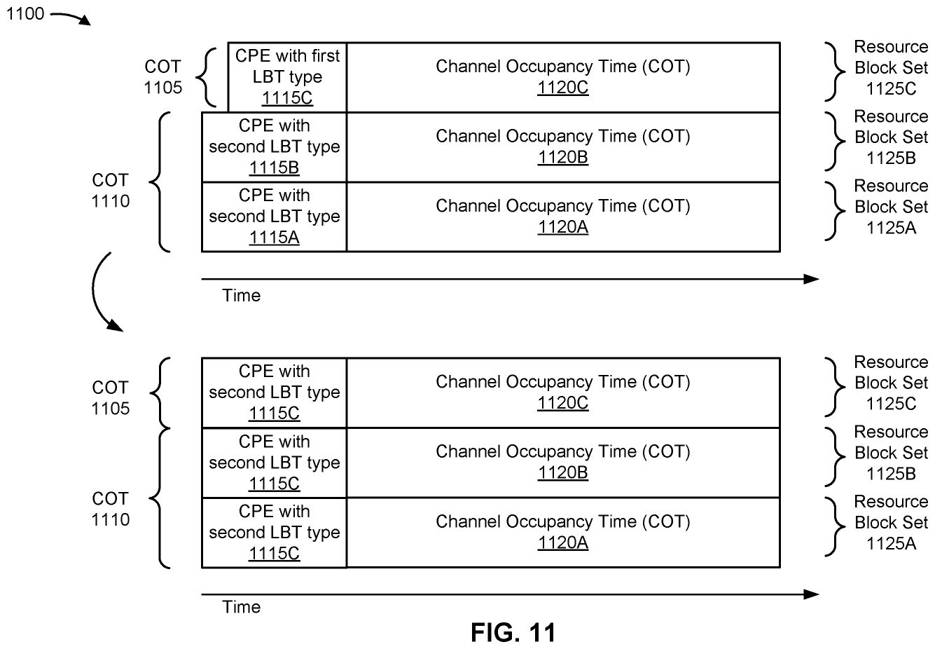

FIG. 11 is a diagram illustrating an example 1100 of communications via RB sets in an LBT-based network, in accordance with the present disclosure.

As shown in FIG. 11, a set of RB sets (e.g., a portion of a shared or unlicensed channel in a frequency domain) may include a COT 1105 and a COT 1110. The COT 1105 may be associated with a CPE with a first LBT type 1115C (e.g., having a first duration). The COT 1110 may be associated with a CPE with a second LBT type 1115B and a CPE with the second LBT type 1115A. The CPE with the first LBT type 1115C may be associated with a COT 1120C, the CPE with the second LBT type 1115B may be associated with a COT 1120B, and the CPE with the second LBT type 1115A may be associated with a COT 1120A. The COT 1105 may be associated with an RB set 1125C and the COT 1110 may be associated with an RB set 1125B and an RB set 1125A.

As shown in FIG. 11, an initial configuration of the CPEs 1115 result in misaligned starting times. Based at least in part on a communication protocol and/or a configuration, a WCD may modify the CPE configurations associated with the CPE with the first LBT type 1115C to align with the CPE configurations associated with the CPE with the second LBT type 1115B and 1115A. This may be based at least in part on modifying CPE configurations associated with a latest start time to match a CPE configuration associated with an earliest start time. In some aspects, the CPE configurations associated with an earliest start time may be used based at least in part on a gap after picking the earliest start time being greater than or equal to a threshold time (e.g., 25 us).

As indicated above, FIG. 11 is provided as an example. Other examples may differ from what is described with respect to FIG. 11.

FIG. 12 is a diagram illustrating an example process 1200 performed, for example, by a WCD, in accordance with the present disclosure. Example process 1200 is an example where the WCD (e.g., UE 120 or network node 110) performs operations associated with mixed COT.

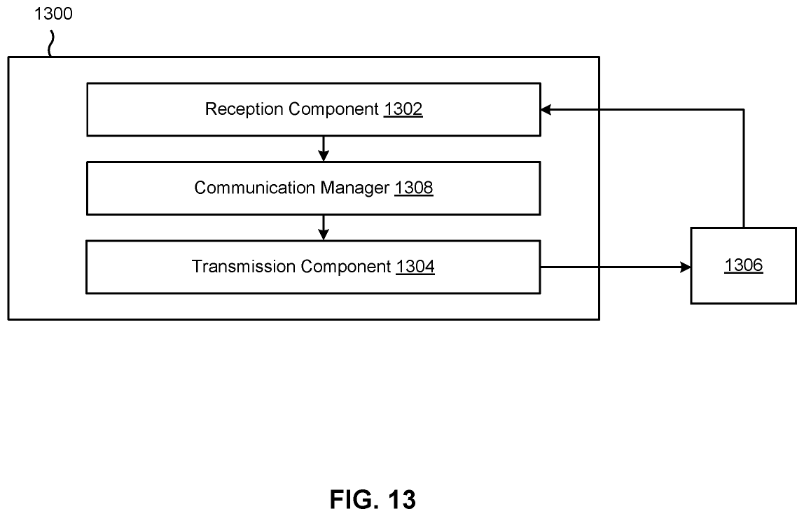

As shown in FIG. 12, in some aspects, process 1200 may include receiving, from one or more additional WCDs, one or more indications of available RB sets and associated CPE configurations, the available RB sets associated with a mixed COT (block 1210). For example, the WCD (e.g., using communication manager 150 or 140 and/or reception component 1302, depicted in FIG. 13) may receive, from one or more additional WCDs, one or more indications of available RB sets and associated CPE configurations, the available RB sets associated with a mixed COT, as described above.

As further shown in FIG. 12, in some aspects, process 1200 may include modifying at least one of the CPE configurations to time-align the available RB sets for transmission of one or more communications (block 1220). For example, the WCD (e.g., using communication manager 150 or 140 and/or communication manager 1308, depicted in FIG. 13) may modify at least one of the CPE configurations to time-align the available RB sets for transmission of one or more communications, as described above.

As further shown in FIG. 12, in some aspects, process 1200 may include transmitting the one or more communications via the available RB sets (block 1230). For example, the WCD (e.g., using communication manager 150 or 150 and/or transmission component 1304, depicted in FIG. 13) may transmit the one or more communications via the available RB sets, as described above.

Process 1200 may include additional aspects, such as any single aspect or any combination of aspects described below and/or in connection with one or more other processes described elsewhere herein.

In a first aspect, modifying the at least one of the CPE configurations comprises modifying an earliest CPE start time to match a latest CPE start time, or modifying the latest CPE start time to match the earliest CPE start time.

In a second aspect, alone or in combination with the first aspect, modifying the at least one of the CPE configurations comprises modifying a type of LBT applied to one or more of the CPE configurations.

In a third aspect, alone or in combination with one or more of the first and second aspects, modifying the at least one of the CPE configurations comprises modifying a CPE start time associated with a self-initiated COT operation to match a CPE start time of a shared COT operation.

In a fourth aspect, alone or in combination with one or more of the first through third aspects, modifying the at least one of the CPE configurations is based at least in part on one or more of one or more LBT types associated with the CPE configurations, or a gap between a latest CPE start time and an end of a latest transmitted slot in a COT operation preceding CPE start time.

In a fifth aspect, alone or in combination with one or more of the first through fourth aspects, receiving the one or more indications of the available RB sets and associated CPE configurations comprises one or more of receiving an indication of whether a LBT type, associated with the available RB sets, supports a modification to a different LBT type.

In a sixth aspect, alone or in combination with one or more of the first through fifth aspects, process 1200 includes transmitting an indication of whether resources of the available RB sets are available for a COT-initiating WCD to use for transmission to additional WCDs.

In a seventh aspect, alone or in combination with one or more of the first through sixth aspects, the indication of whether the available RB sets are available for the COT-initiating WCD to use for transmission to additional WCDs using the available RB sets comprises indications of LBT bandwidths, of the available RB sets, that are available for the COT-initiating WCD to use for transmission to additional WCDs, and indications of LBT bandwidths, of the available RB sets, that are not available for the COT-initiating WCD to use for transmission to additional WCDs using the available RB sets.

In an eighth aspect, alone or in combination with one or more of the first through seventh aspects, transmitting the one or more communications via the available RB sets comprises transmitting, to an additional WCD, a communication using a subset of the available RB sets, wherein the subset is associated with a LBT operation performed by the additional WCD or the WCD.

In a ninth aspect, alone or in combination with one or more of the first through eighth aspects, transmitting the one or more communications via the available RB sets comprises transmitting, to an additional WCD, a communication using the available RB sets based at least in part on one or more of the WCD performing a LBT operation on a first portion of the available RB sets, or the additional WCD performing an LBT operation on a second portion of the available RB sets.

In a tenth aspect, alone or in combination with one or more of the first through ninth aspects, the first portion satisfies a threshold portion of the available RBs sets, the second portion satisfies the threshold portion of the available RBs sets, or a combination of the first portion and the second portion satisfies the threshold portion of the available RBs sets.

In an eleventh aspect, alone or in combination with one or more of the first through tenth aspects, the available RB sets are associated with one or more LBT operations performed on a randomly selected primary channel within a subset of the available RB sets, wherein the subset of the available RB sets are not initiated before performance of the one or more LBT operations.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a WCD, or a WCD may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 1308 (e.g., the communication manager 150 or 140).

In some aspects, the apparatus 1300 may be configured to perform one or more operations described herein in connection with FIGS. 8-11. Additionally, or alternatively, the apparatus 1300 may be configured to perform one or more processes described herein, such as process 1200 of FIG. 12. In some aspects, the apparatus 1300 and/or one or more components shown in FIG. 13 may include one or more components of the WCD described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the WCD described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the WCD described in connection with FIG. 2. In some aspects, the transmission component 1304 may be co-located with the reception component 1302 in a transceiver.

The reception component 1302 may receive, from one or more additional WCDs, one or more indications of available RB sets and associated CPE configurations, the available RB sets associated with a mixed COT. The communication manager 1308 may modify at least one of the CPE configurations to time-align the available RB sets for transmission of one or more communications. The transmission component 1304 may transmit the one or more communications via the available RB sets.

The transmission component 1304 may transmit an indication of whether resources of the available RB sets are available for a COT-initiating WCD to use for transmission to additional WCDs.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:
Aspect 1: A method of wireless communication performed by a wireless communication device (WCD), comprising: receiving, from one or more additional WCDs, one or more indications of available resource block sets and associated cyclic prefix extension (CPE) configurations, the available resource block sets associated with a mixed channel-occupancy time (COT); modifying at least one of the CPE configurations to time-align the available resource block sets for transmission of one or more communications; and transmitting the one or more communications via the available resource block sets.
Aspect 2: The method of Aspect 1, wherein modifying the at least one of the CPE configurations comprises: modifying an earliest CPE start time to match a latest CPE start time, or modifying the latest CPE start time to match the earliest CPE start time.
Aspect 3: The method of any of Aspects 1-2, wherein modifying the at least one of the CPE configurations comprises: modifying a type of listen-before-talk (LBT) applied to one or more of the CPE configurations.
Aspect 4: The method of any of Aspects 1-3, wherein modifying the at least one of the CPE configurations comprises: modifying a CPE start time associated with a self-initiated COT operation to match a CPE start time of a shared COT operation.
Aspect 5: The method of any of Aspects 1-4, wherein modifying the at least one of the CPE configurations is based at least in part on one or more of: one or more listen-before-talk (LBT) types associated with the CPE configurations, or a gap between a latest CPE start time and an end of a latest transmitted slot in a COT operation preceding CPE start time.
Aspect 6: The method of any of Aspects 1-5, wherein receiving the one or more indications of the available resource block sets and associated CPE configurations comprises one or more of: receiving an indication of whether a listen-before-talk (LBT) type, associated with the available resource block sets, supports a modification to a different LBT type.
Aspect 7: The method of any of Aspects 1-6, further comprising: transmitting an indication of whether resources of the available resource block sets are available for a COT-initiating WCD to use for transmission to additional WCDs.
Aspect 8: The method of Aspect 7, wherein the indication of whether the available resource block sets are available for the COT-initiating WCD to use for transmission to additional WCDs using the available resource block sets comprises: indications of LBT bandwidths, of the available resource block sets, that are available for the COT-initiating WCD to use for transmission to additional WCDs, and indications of LBT bandwidths, of the available resource block sets, that are not available for the COT-initiating WCD to use for transmission to additional WCDs using the available resource block sets.
Aspect 9: The method of any of Aspects 1-8, wherein transmitting the one or more communications via the available resource block sets comprises: transmitting, to an additional WCD, a communication using a subset of the available resource block sets, wherein the subset is associated with a listen-before-talk (LBT) operation performed by the additional WCD or the WCD.
Aspect 10: The method of any of Aspects 1-9, wherein transmitting the one or more communications via the available resource block sets comprises: transmitting, to an additional WCD, a communication using the available resource block sets based at least in part on one or more of: the WCD performing a listen-before-talk (LBT) operation on a first portion of the available resource block sets, or the additional WCD performing an LBT operation on a second portion of the available resource block sets.
Aspect 11: The method of Aspect 10, wherein the first portion satisfies a threshold portion of the available resource blocks sets, wherein the second portion satisfies the threshold portion of the available resource blocks sets, or wherein a combination of the first portion and the second portion satisfies the threshold portion of the available resource blocks sets.
Aspect 12: The method of any of Aspects 1-11, wherein the available resource block sets are associated with one or more listen-before-talk (LBT) operations performed on a randomly selected primary channel within a subset of the available resource block sets, wherein the subset of the available resource block sets are not initiated before performance of the one or more LBT operations.
Aspect 13: An apparatus for wireless communication at a device, comprising a processor; memory coupled with the processor; and instructions stored in the memory and executable by the processor to cause the apparatus to perform the method of one or more of Aspects 1-12.
Aspect 14: A device for wireless communication, comprising a memory and one or more processors coupled to the memory, the one or more processors configured to perform the method of one or more of Aspects 1-12.
Aspect 15: An apparatus for wireless communication, comprising at least one means for performing the method of one or more of Aspects 1-12.
Aspect 16: A non-transitory computer-readable medium storing code for wireless communication, the code comprising instructions executable by a processor to perform the method of one or more of Aspects 1-12.
Aspect 17: A non-transitory computer-readable medium storing a set of instructions for wireless communication, the set of instructions comprising one or more instructions that, when executed by one or more processors of a device, cause the device to perform the method of one or more of Aspects 1-12.

The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A wireless communication device (WCD) for wireless communication, comprising:
a memory; and
one or more processors, coupled to the memory, configured to:
receive, from one or more additional WCDs, one or more indications of available resource block sets and associated cyclic prefix extension (CPE) configurations, the available resource block sets associated with a mixed channel-occupancy time (COT);
modify at least one of the CPE configurations to time-align the available resource block sets for transmission of one or more communications; and
transmit the one or more communications via the available resource block sets.

2. The WCD of claim 1, wherein the one or more processors, to modify the at least one of the CPE configurations, are configured to:
modify an earliest CPE start time to match a latest CPE start time, or
modify the latest CPE start time to match the earliest CPE start time.

3. The WCD of claim 1, wherein the one or more processors, to modify the at least one of the CPE configurations, are configured to:
modify a type of listen-before-talk (LBT) applied to one or more of the CPE configurations.

4. The WCD of claim 1, wherein the one or more processors, to modify the at least one of the CPE configurations, are configured to:
modify a CPE start time associated with a self-initiated COT operation to match a CPE start time of a shared COT operation.

5. The WCD of claim 1, wherein modifying the at least one of the CPE configurations is based at least in part on one or more of:
one or more listen-before-talk (LBT) types associated with the CPE configurations, or
a gap between a latest CPE start time and an end of a latest transmitted slot in a COT operation preceding CPE start time.

6. The WCD of claim 1, wherein the one or more processors, to receive the one or more indications of the available resource block sets and associated CPE configurations, are configured to:
receive an indication of whether a listen-before-talk (LBT) type, associated with the available resource block sets, supports a modification to a different LBT type.

7. The WCD of claim 1, wherein the one or more processors are further configured to:
transmit an indication of whether resources of the available resource block sets are available for a COT-initiating WCD to use for transmission to additional WCDs.

8. The WCD of claim 7, wherein the indication of whether the available resource block sets are available for the COT-initiating WCD to use for transmission to additional WCDs using the available resource block sets comprises:
indications of LBT bandwidths, of the available resource block sets, that are available for the COT-initiating WCD to use for transmission to additional WCDs, and
indications of LBT bandwidths, of the available resource block sets, that are not available for the COT-initiating WCD to use for transmission to additional WCDs using the available resource block sets.

9. The WCD of claim 1, wherein the one or more processors, to transmit the one or more communications via the available resource block sets, are configured to:
transmit, to an additional WCD, a communication using a subset of the available resource block sets, wherein the subset is associated with a listen-before-talk (LBT) operation performed by the additional WCD or the WCD.

10. The WCD of claim 1, wherein the one or more processors, to transmit the one or more communications via the available resource block sets, are configured to:
transmit, to an additional WCD, a communication using the available resource block sets based at least in part on one or more of:
the WCD performing a listen-before-talk (LBT) operation on a first portion of the available resource block sets, or
the additional WCD performing an LBT operation on a second portion of the available resource block sets.

11. The WCD of claim 10, wherein the first portion satisfies a threshold portion of the available resource blocks sets,
wherein the second portion satisfies the threshold portion of the available resource blocks sets, or
wherein a combination of the first portion and the second portion satisfies the threshold portion of the available resource blocks sets.

12. The WCD of claim 1, wherein the available resource block sets are associated with one or more listen-before-talk (LBT) operations performed on a randomly selected primary channel within a subset of the available resource block sets,
wherein the subset of the available resource block sets are not initiated before performance of the one or more LBT operations.

13. A method of wireless communication performed by a wireless communication device (WCD), comprising:
receiving, from one or more additional WCDs, one or more indications of available resource block sets and associated cyclic prefix extension (CPE) configurations, the available resource block sets associated with a mixed channel-occupancy time (COT);
modifying at least one of the CPE configurations to time-align the available resource block sets for transmission of one or more communications; and
transmitting the one or more communications via the available resource block sets.

14. The method of claim 13, wherein modifying the at least one of the CPE configurations comprises:
modifying an earliest CPE start time to match a latest CPE start time, or
modifying the latest CPE start time to match the earliest CPE start time.

15. The method of claim 13, wherein modifying the at least one of the CPE configurations comprises:
modifying a type of listen-before-talk (LBT) applied to one or more of the CPE configurations.

16. The method of claim 13, wherein modifying the at least one of the CPE configurations comprises:
modifying a CPE start time associated with a self-initiated COT operation to match a CPE start time of a shared COT operation.

17. The method of claim 13, wherein modifying the at least one of the CPE configurations is based at least in part on one or more of:
one or more listen-before-talk (LBT) types associated with the CPE configurations, or
a gap between a latest CPE start time and an end of a latest transmitted slot in a COT operation preceding CPE start time.

18. The method of claim 13, wherein receiving the one or more indications of the available resource block sets and associated CPE configurations comprises one or more of:
receiving an indication of whether a listen-before-talk (LBT) type, associated with the available resource block sets, supports a modification to a different LBT type.

19. The method of claim 13, further comprising:
transmitting an indication of whether resources of the available resource block sets are available for a COT-initiating WCD to use for transmission to additional WCDs.

20. The method of claim 19, wherein the indication of whether the available resource block sets are available for the COT-initiating WCD to use for transmission to additional WCDs using the available resource block sets comprises:
indications of LBT bandwidths, of the available resource block sets, that are available for the COT-initiating WCD to use for transmission to additional WCDs, and
indications of LBT bandwidths, of the available resource block sets, that are not available for the COT-initiating WCD to use for transmission to additional WCDs using the available resource block sets.

21. The method of claim 13, wherein transmitting the one or more communications via the available resource block sets comprises:
transmitting, to an additional WCD, a communication using a subset of the available resource block sets, wherein the subset is associated with a listen-before-talk (LBT) operation performed by the additional WCD or the WCD.

22. The method of claim 13, wherein transmitting the one or more communications via the available resource block sets comprises:
transmitting, to an additional WCD, a communication using the available resource block sets based at least in part on one or more of:
the WCD performing a listen-before-talk (LBT) operation on a first portion of the available resource block sets, or
the additional WCD performing an LBT operation on a second portion of the available resource block sets.

23. The method of claim 22, wherein the first portion satisfies a threshold portion of the available resource blocks sets,
wherein the second portion satisfies the threshold portion of the available resource blocks sets, or
wherein a combination of the first portion and the second portion satisfies the threshold portion of the available resource blocks sets.

24. The method of claim 13, wherein the available resource block sets are associated with one or more listen-before-talk (LBT) operations performed on a randomly selected primary channel within a subset of the available resource block sets,
wherein the subset of the available resource block sets are not initiated before performance of the one or more LBT operations.

25. A non-transitory computer-readable medium storing a set of instructions for wireless communication, the set of instructions comprising:
one or more instructions that, when executed by one or more processors of a wireless communication device (WCD), cause the WCD to:
receive, from one or more additional WCDs, one or more indications of available resource block sets and associated cyclic prefix extension (CPE) configurations, the available resource block sets associated with a mixed channel-occupancy time (COT);
modify at least one of the CPE configurations to time-align the available resource block sets for transmission of one or more communications; and
transmit the one or more communications via the available resource block sets.

26. The non-transitory computer-readable medium of claim 25, wherein the one or more instructions, that cause the WCD to modify the at least one of the CPE configurations, cause the WCD to:
modify an earliest CPE start time to match a latest CPE start time,
modify the latest CPE start time to match the earliest CPE start time, or
modify a CPE start time associated with a self-initiated COT operation to match a CPE start time of a shared COT operation.

27. The non-transitory computer-readable medium of claim 25, wherein the one or more instructions, that cause the WCD to modify the at least one of the CPE configurations, cause the WCD to:
modify a type of listen-before-talk (LBT) applied to one or more of the CPE configurations.

28. An apparatus for wireless communication, comprising:
means for receiving, from one or more wireless communication devices (WCDs), one or more indications of available resource block sets and associated cyclic prefix extension (CPE) configurations, the available resource block sets associated with a mixed channel-occupancy time (COT);
means for modifying at least one of the CPE configurations to time-align the available resource block sets for transmission of one or more communications; and
means for transmitting the one or more communications via the available resource block sets.

29. The apparatus of claim 28, wherein the means for modifying the at least one of the CPE configurations comprises:
means for modifying an earliest CPE start time to match a latest CPE start time,
means for modifying the latest CPE start time to match the earliest CPE start time, or
means for modifying a CPE start time associated with a self-initiated COT operation to match a CPE start time of a shared COT operation.

30. The apparatus of claim 28, wherein the means for modifying the at least one of the CPE configurations comprises:
means for modifying a type of listen-before-talk (LBT) applied to one or more of the CPE configurations.
